(19) United States
(12) Patent Application Publication
(10) Pub. No.: US 2013/0286110 A1
(43) Pub. Date: Oct. 31, 2013

(54) SNAP-ON SEAL FOR INKJET INK TANK

(71) Applicants: Kevin J. O'Leary, Rochester, NY (US); Steven Lee Moore, Dansville, NY (US)

(72) Inventors: Kevin J. O'Leary, Rochester, NY (US); Steven Lee Moore, Dansville, NY (US)

(21) Appl. No.: 13/459,514

(22) Filed: Apr. 30, 2012

(51) Int. Cl. B41J 2/175

(52) U.S. Cl. 347/85

(57) ABSTRACT

A seal for an outlet port of an ink tank, the seal includes a seal member; and a seal retainer having a housing for the seal member; a first hook on a first side of the seal retainer; a second hook on a second side of the seal retainer, the second side being opposite the first side; a handle including a free end and a hinged end opposite the free end; and a hinge member disposed between the housing and the free end of the handle, wherein a distance between the free end of the handle and the hinged end of the handle is greater than a distance between the hinged end of the handle and an end of the seal retainer that is opposite the free end of the handle.

### CROSS REFERENCE TO RELATED APPLICATIONS

Reference is made to commonly assigned U.S. patent application Ser. No. ______ filed concurrently herewith by Kevin J. O'Leary and Steven L. Moore, entitled “Inkjet Ink Tank for Snap-On Seal”, commonly assigned U.S. patent application Ser. No. ______ filed concurrently herewith by Michael L. Dececca, Douglas H. Pearson and Steven L. Moore, entitled “Ink Tank Seal Retainer with Symmetric Seal Force”, and commonly assigned U.S. patent application Ser. No. ______ filed concurrently herewith by Joseph W. Hoff, Douglas H. Pearson, Steven L. Moore, Michael L. Dececca and Kevin J. O'Leary, entitled “Seal Retainer with Retainer Spreaders on Handle”, the disclosures of which are herein incorporated by reference.

### FIELD OF THE INVENTION

The present invention relates generally to an ink tank for an inkjet printer, and more particularly to a seal including a seal retainer for sealing an outlet port of the ink tank during, for example, shipping and storage.

### BACKGROUND OF THE INVENTION

An inkjet printing system typically includes one or more printheads and their corresponding ink supplies. Each printhead includes an ink inlet that is connected to its ink supply and an array of drop ejectors, each ejector consisting of an ink pressurization chamber, an ejecting actuator and a nozzle through which droplets of ink are ejected. The ejecting actuator can be one of various types, including a heater that vaporizes some of the ink in the pressurization chamber in order to propel a droplet out of the orifice, or a piezoelectric device which changes the wall geometry of the chamber in order to generate a pressure wave that ejects a droplet. The droplets are typically directed toward paper or other recording medium in order to produce an image according to image data that is converted into electronic firing pulses for the drop ejectors as the recording medium is moved relative to the printhead.

A common type of printer architecture is the carriage printer, where the printhead nozzle array is somewhat smaller than the extent of the region of interest for printing on the recording medium and the printhead is mounted on a carriage. In a carriage printer, the recording medium is advanced a given distance along a media advance direction and then stopped. While the recording medium is stopped, the printhead carriage is moved in a direction that is substantially perpendicular to the media advance direction as the drops are ejected from the nozzles. After the carriage has printed a swath of the image while traversing the recording medium, the recording medium is advanced; the carriage direction of motion is reversed; and the image is formed swath by swath.

The ink supply on a carriage printer can be mounted on the carriage or off the carriage. For the case of ink supplies being mounted on the carriage, the ink tank can be permanently integrated with the printhead as a print cartridge so that the printhead needs to be replaced when the ink is depleted, or the ink tank can be detachably mounted to the printhead so that only the ink tank itself needs to be replaced when the ink tank is depleted. Detachably mounted ink tanks for a carriage printer typically contain only enough ink for up to about several hundred prints. This is because the total mass of the carriage needs be limited so that accelerations of the carriage at each end of the travel do not result in large forces that can shake the printer back and forth. As a result, users of carriage printers need to replace carriage-mounted ink tanks periodically depending on their printing usage, typically several times per year. Consequently, the task of replacing a detachably mounted ink tank in the holding receptacle should be simple and reliable Ink tanks can contain a single color ink, or they can have several ink chambers each containing a different color ink that is supplied to the printhead through a corresponding outlet port.

Inkjet ink includes a variety of volatile and nonvolatile components including pigments or dyes, humectants, image durability enhancers, and carriers or solvents. For proper operation of the inkjet printhead it is important that the ink transferred from the outlet port of the ink tank to the inlet port of the printhead has the appropriate balance of these ink components. Therefore, during shipping and storage of an inkjet ink tank, it is common practice to provide a seal over the outlet port(s) of the ink tank in order to inhibit the evaporative loss of the volatile components of the ink. U.S. Pat. No. 6,464,339 discloses a removable seal that is adhesively attached over the outlet port of an ink tank. U.S. Pat. No. 7,967,426 (incorporated herein by reference) discloses a sealing device including a compliant sealing member and a retainer having a latching feature to facilitate latching of the sealing device to an ink tank and also a protective region for protecting a circuit device on the ink tank. U.S. Patent Application Publication 2011/0292137 (incorporated herein by reference) discloses a sealing device including a seal retainer with a seal housing having attachment members that are attached to the ink tank by welding, for example, and a hinged handle for removing the seal retainer.

The various removable seals disclosed in the prior art work in a satisfactory fashion, but what is needed in some applications is a seal and seal retainer that has improved ease of assembly and removal, while still being highly effective in preventing evaporative loss of volatile ink components.

### SUMMARY OF THE INVENTION

The present invention is directed to overcoming one or more of the problems set forth above. Briefly summarized, according to one aspect of the invention, the invention resides in a seal for an outlet port of an ink tank, the seal comprising a seal member; and a seal retainer comprising; a housing for the seal member; a first hook on a first side of the seal retainer; a second hook on a second side of the seal retainer, the second side being opposite the first side; a handle including a free end and a hinged end opposite the free end; and a hinge member disposed between the housing and the free end of the handle, wherein a distance between the free end of the handle and the hinged end of the handle is greater than a distance between the hinged end of the handle and an end of the seal retainer that is opposite the free end of the handle.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

FIG. 1 is a schematic representation of an inkjet printer system;

FIG. 2 is a perspective of a portion of a printhead;

FIG. 3 is a perspective of a portion of a carriage printer;

FIG. 4 is a schematic side view of an exemplary paper path in a carriage printer;

FIG. 5 is a perspective of a portion of a printhead;

FIG. 6 is a perspective of an ink tank with outlet port facing up, according to an embodiment of the invention;

FIG. 7 is a perspective of the ink tank of FIG. 6 with outlet port facing down and with a seal installed over the outlet port, according to an embodiment of the invention;

FIG. 8 is similar to FIG. 7 but with the outlet port facing up;

FIG. 9 is a cross section through A-A′ of FIG. 8;

FIG. 10 is a cross-section similar to FIG. 9, but without the seal;

FIG. 11 is an outer perspective of the seal of FIG. 8 without the ink tank;

FIG. 12 an inner perspective of the seal, rotated with respect to FIG. 11;

FIG. 13 is a perspective of the sealing face of the seal member;

FIG. 14 is a perspective of the attachment face of the seal member;

FIG. 15 shows a perspective of the seal retainer in a first step of removal from the ink tank; and

FIG. 16 shows a perspective of the seal retainer in a second step of removal from the ink tank.

### DETAILED DESCRIPTION OF THE INVENTION

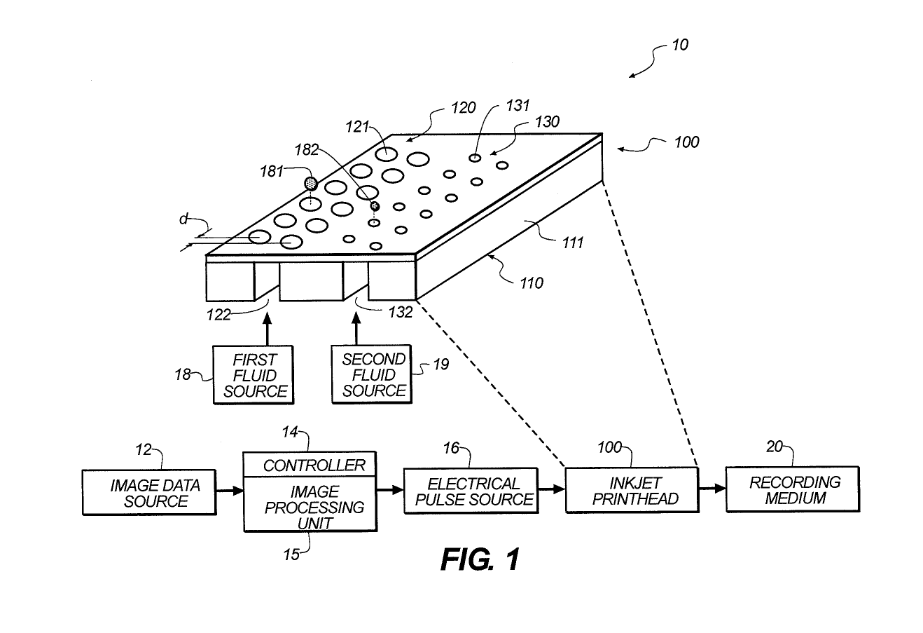

Referring to FIG. 1, a schematic representation of an inkjet printer system 10 is shown, for its usefulness with the present invention and is fully described in U.S. Pat. No. 7,350,902, and is incorporated by reference herein in its entirety. The inkjet printer system 10 includes an image data source 12, which provides data signals that are interpreted by a controller 14 as being commands to eject drops. The controller 14 includes an image processing unit 15 for rendering images for printing, and outputs signals to an electrical pulse source 16 of electrical energy pulses that are inputted to an inkjet printhead 100, which includes at least one inkjet printhead die 110.

In the example shown in FIG. 1, there are two nozzle arrays 120 and 130. Nozzles 121 in the first nozzle array 120 have a larger opening area than nozzles 131 in the second nozzle array 130. In this example, each of the two nozzle arrays 120 and 130 has two staggered rows of nozzles 121 and 131, each row having a nozzle density of 600 per inch. The effective nozzle density then in each array is 1200 per inch (i.e. d= 1/1200 inch in FIG. 1). If pixels on a recording medium 20 were sequentially numbered along the paper advance direction, the nozzles 121, 131 from one row of the nozzle array 120, 130 would print the odd numbered pixels, while the nozzles 121, 131 from the other row of the nozzle array 120, 130 would print the even numbered pixels.

A corresponding ink delivery pathway is in fluid communication with each nozzle array 120 and 130. An ink delivery pathway 122 is in fluid communication with the first nozzle array 120, and an ink delivery pathway 132 is in fluid communication with the second nozzle array 130. Portions of ink delivery pathways 122 and 132 are shown in FIG. 1 as openings through printhead die substrate 111. One or more inkjet printhead die 110 will be included in inkjet printhead 100, but for greater clarity only one inkjet printhead die 110 is shown in FIG. 1. In FIG. 1, a first fluid source 18 supplies ink to the first nozzle array 120 via the ink delivery pathway 122, and a second fluid source 19 supplies ink to second nozzle array 130 via the ink delivery pathway 132. Although distinct fluid sources 18 and 19 are shown, in some applications it can be beneficial to have a single fluid source, such as black ink, supplying ink to both the first nozzle array 120 and the second nozzle array 130 via the ink delivery pathways 122 and 132 respectively. Also, in some embodiments, fewer than two or more than two nozzle arrays 120 and 130 can be included on the printhead die 110. In some embodiments, all nozzles 121 and 131 on inkjet printhead die 110 can be the same size, rather than having multiple sized nozzles on the inkjet printhead die 110.

The drop forming mechanisms associated with the nozzles 121, 131 are not shown in FIG. 1. Drop forming mechanisms can be of a variety of types, some of which include a heating element to vaporize a portion of ink and thereby cause ejection of a droplet, or a piezoelectric transducer to constrict the volume of a fluid chamber and thereby cause ejection, or an actuator which is made to move (for example, by heating a bi-layer element) and thereby cause ejection. In any case, electrical pulses from the electrical pulse source 16 are sent to the various drop ejectors according to the desired deposition pattern. In the example of FIG. 1, droplets 181 ejected from the first nozzle array 120 are larger than droplets 182 ejected from the second nozzle array 130, due to the larger nozzle opening area. Typically other aspects of the drop forming mechanisms (not shown) associated respectively with nozzle arrays 120 and 130 are also sized differently in order to optimize the drop ejection process for the different sized drops. During operation, droplets 181 and 182 of ink are deposited on the recording medium 20.

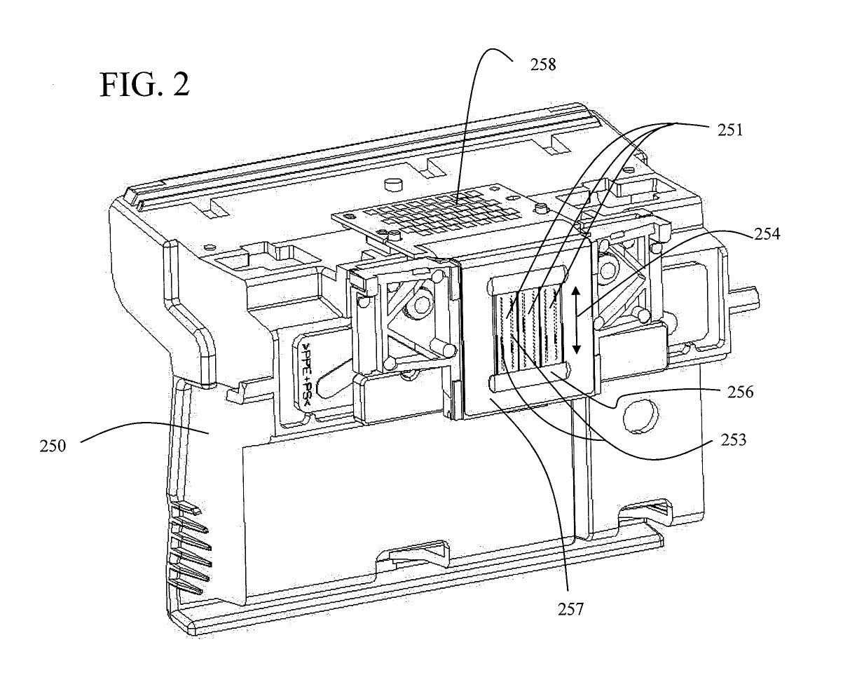

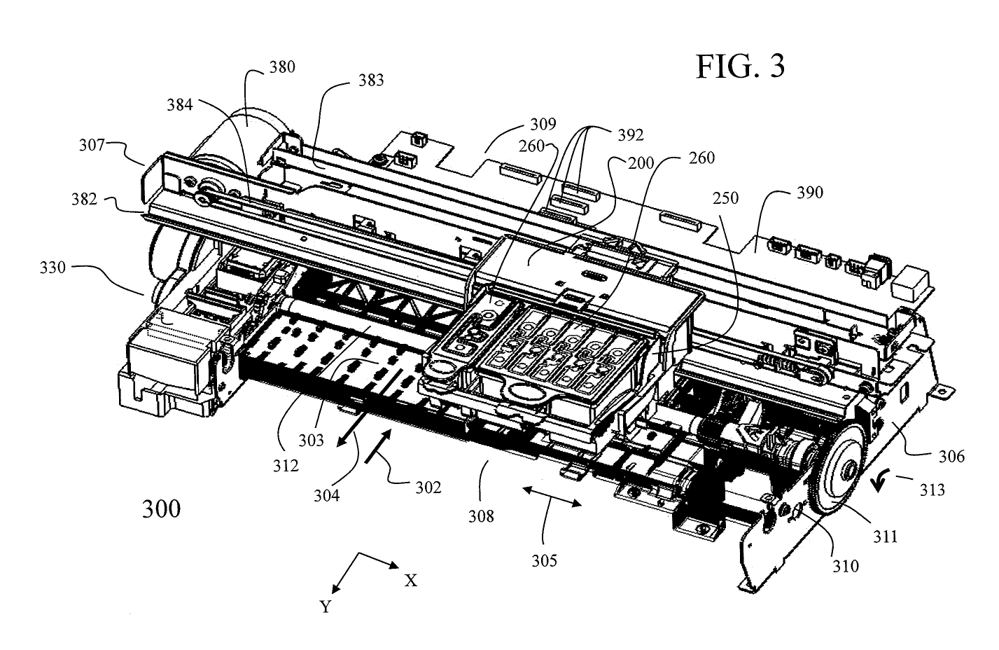

FIG. 2 shows a perspective of a portion of a printhead 250, which is an example of the inkjet printhead 100. The printhead 250 includes three printhead die 251 (similar to printhead die 110 in FIG. 1), each printhead die 251 containing two nozzle arrays 253, so that printhead 250 contains six nozzle arrays 253 altogether. The six nozzle arrays 253 in this example can be connected to ink sources (not shown in FIG. 2); such as cyan, magenta, yellow, text black, and photo black. Two of the nozzle arrays 253 can be connected to a single ink source such as text black. Each of the six nozzle arrays 253 is disposed along a nozzle array direction 254, and the length of each nozzle array 253 along the nozzle array direction 254 is typically on the order of 1 inch or less. Typical lengths of the recording medium 20 are 6 inches for photographic prints (4 inches by 6 inches) or 11 inches for paper (8.5 by 11 inches). Thus, in order to print a full image, a number of swaths are successively printed while moving the printhead 250 across the recording medium 20. Following the printing of a swath, the recording medium 20 is advanced along a media advance direction 304 (FIG. 3) that is substantially parallel to the nozzle array direction 254.

A flex circuit 257 is electrically connected to the printhead die 251, for example by wire bonding or TAB bonding. The interconnections are covered by an encapsulant 256 to protect them. The flex circuit 257 bends around the side of the printhead 250 and connects to a connector board 258. When the printhead 250 is mounted into a carriage 200 (see FIG. 3), connector board 258 is electrically connected to a connector (not shown) on the carriage 200, so that electrical signals can be transmitted to the printhead die 251.

A portion of a desktop carriage printer is shown in FIG. 3. Some of the parts of the printer have been hidden in the view shown in FIG. 3 so that other parts can be more clearly seen. A printer chassis 300 has a print region 303 across which the carriage 200 is moved back and forth in a carriage scan direction 305 along the X axis, between a right side 306 and a left side 307 of the printer chassis 300, while drops are ejected from the printhead die 251 (not shown in FIG. 3) on the printhead 250 that is mounted on the carriage 200. A carriage motor 380 moves a belt 384 to move the carriage 200 along a carriage guide rail 382. An encoder sensor (not shown) is mounted on the carriage 200 and indicates carriage location relative to an encoder fence 383.

The printhead 250 is mounted in the carriage 200, and ink tanks 260 are installed in the printhead 250. The mounting orientation of the printhead 250 is rotated relative to the view in FIG. 2, so that the printhead die 251 are located at the bottom side of the printhead 250, the droplets 181 and 182 (see FIG. 1) of ink being ejected downward onto the recording medium 20 (see FIG. 1) in the print region 303 in the view of FIG. 3.

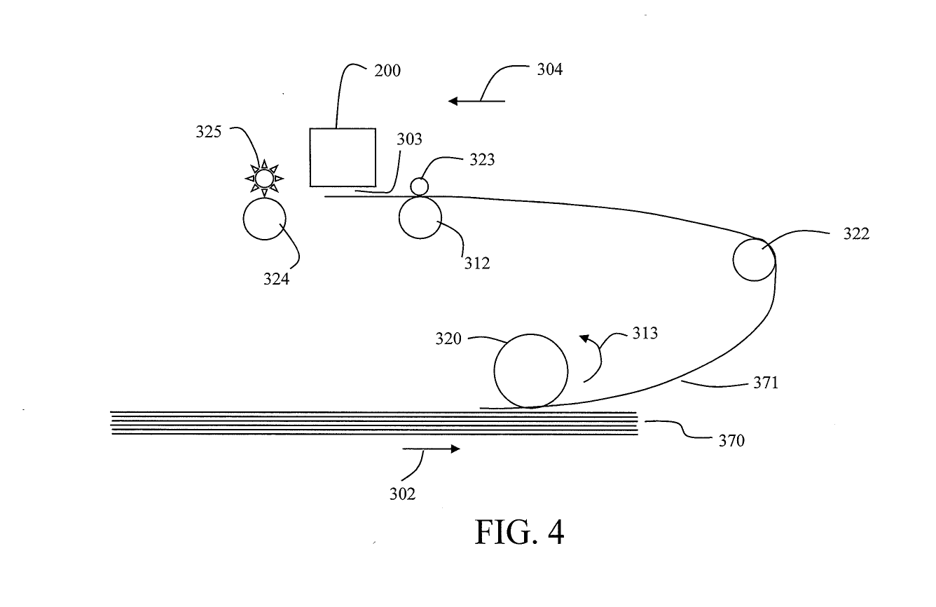

Paper or other recording medium 20 (sometimes generically referred to as paper or media herein) is loaded along a paper load entry direction 302 toward a front 308 of printer chassis 300. A variety of rollers are used to advance the recording medium 20 through the printer as shown schematically in the side view of FIG. 4. In this example, a pick-up roller 320 moves a top piece or sheet 371 of a stack 370 of paper or other recording medium 20 in the direction of arrow, the paper load entry direction 302. A turn roller 322 acts to move the paper around a C-shaped path (in cooperation with a curved rear wall surface) so that the paper continues to advance along the media advance direction 304 from a rear 309 of the printer chassis 300 (with reference also to FIG. 3). The paper is then moved by a feed roller 312 and idler roller(s) 323 to advance along the Y axis across the print region 303, and from there to a discharge roller 324 and star wheel(s) 325 so that printed paper exits along the media advance direction 304. The feed roller 312 includes a feed roller shaft along its axis, and a feed roller gear 311 is mounted on a feed roller shaft. The feed roller 312 can include a separate roller mounted on the feed roller shaft, or can include a thin high friction coating on the feed roller shaft. A rotary encoder (not shown) can be coaxially mounted on the feed roller shaft in order to monitor the angular rotation of the feed roller 312.

A motor that powers the paper advance rollers is not shown in FIG. 3, but a hole 310 at the right side 306 of the printer chassis 300 is where a motor gear (not shown) protrudes through in order to engage the feed roller gear 311, as well as the gear for the discharge roller (not shown). For normal paper pick-up and feeding, it is desired that all rollers rotate in a forward rotation direction 313. A maintenance station 330 is disposed toward the left side 307 of the printer chassis 300 in the example of FIG. 3.

Toward the rear 309 of the printer chassis 300, in this example, is located an electronics board 390, which includes cable connectors 392 for communicating via cables (not shown) to the printhead carriage 200 and from there to the printhead 250. Also on the electronics board 390 are typically mounted motor controllers for the carriage motor 380 and for the paper advance motor, a processor and/or other control electronics (shown schematically as the controller 14 and image processing unit 15 in FIG. 1) for controlling the printing process, and an optional connector for a cable to a host computer.

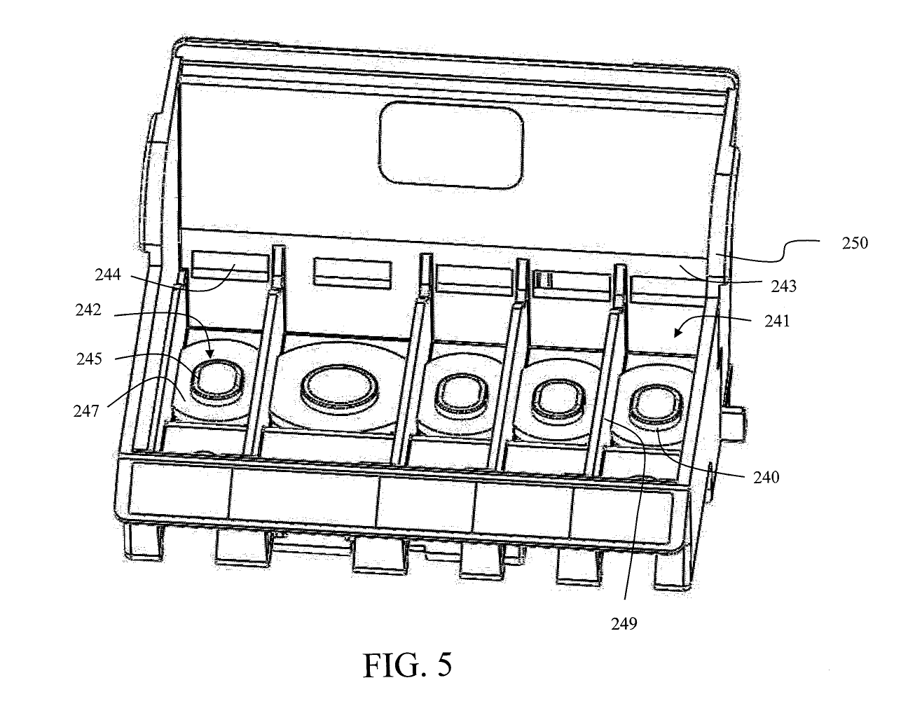

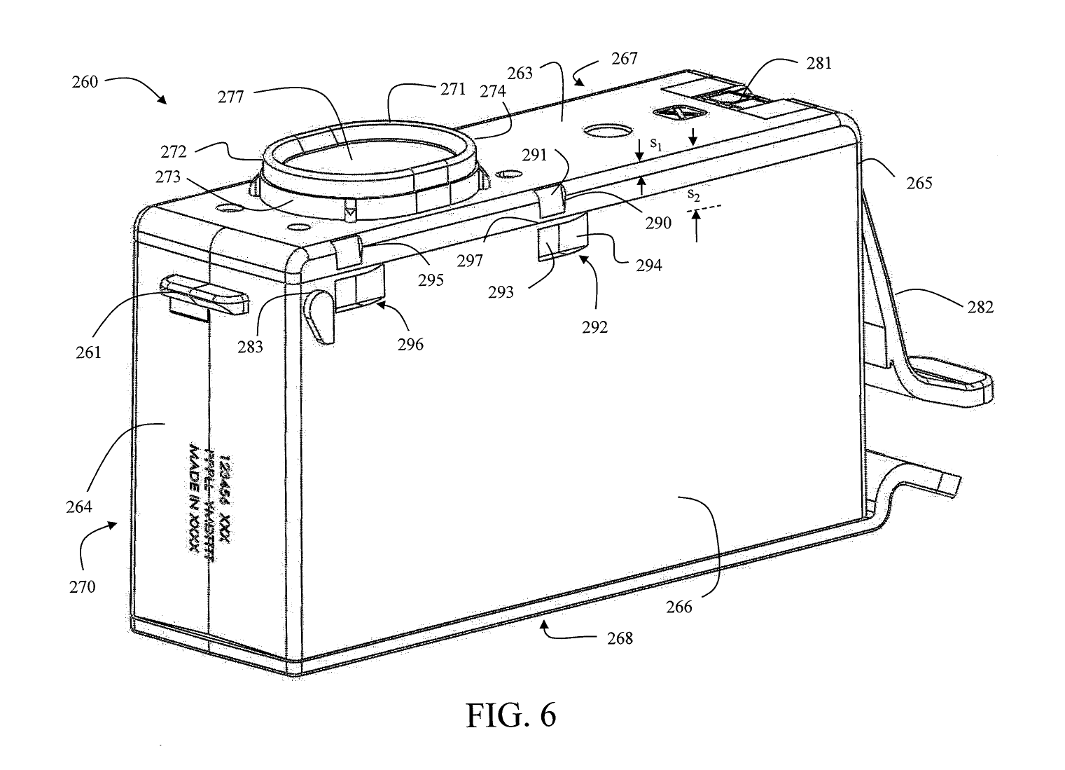

FIG. 5 shows a perspective of the printhead 250 (rotated with respect to FIG. 2) without the replaceable ink tanks 260 mounted onto it. In this example, the individual ink tanks 260 (FIG. 6) are detachably mountable in an ink tank holding receptacles 241. The holding receptacles 241 are separated from each other by partitioning walls 249. Five inlet ports 242 are shown in the corresponding holding receptacles 241. Each inlet port 242 is fluidically connected with a corresponding outlet port 272 (FIG. 6) of the ink tank 260 when it is installed onto the printhead 250. In the example of FIG. 5 each inlet port 242 has the form of a standpipe 240 that extends from the floor of the printhead 250. Typically a filter (such as woven or mesh wire filter, not shown) covers an end 245 of the standpipe 240. The size of end 245 of the standpipe 240 is typically smaller than that of the opening of outlet port 272 (see FIG. 6) of the ink tank 260, so that the end 245 of each standpipe 240 is pressed into contact with a corresponding wick 277 at the opening of the outlet port 272. In other words, the wick 277 serves as a printhead interface member for the ink tank 260. On the floor of the printhead 250 surrounding the standpipes 240 of the inlet ports 242 is an elastomeric gasket 247 for sealing against an end face 271 of outlet port 272 of the ink tank 260 to keep air from leaking into the ink passageways. When an ink tank 260 is installed into the corresponding ink tank holding receptacle 241 of the printhead 250, it is in fluid communication with the printhead 250 because of the connection of the wick 277 at outlet port 272 with the end 245 of the standpipe 240 of the inlet port 242. Also shown in FIG. 5 is an opening 244 in an inner wall 243 of each holding receptacle 241 that is provided for engaging with a protrusion 261 (FIG. 6).

An exemplary ink tank 260 is shown in FIG. 6. The ink tank 260 includes a body 270 with a lid 268 affixed to it. The ink tank body 270 includes an outlet wall 263; a lead end wall 264 that is configured to be near the printhead 250 when installation of the ink tank 260 into the printhead 250 (FIG. 5) begins; a trail end wall 265 that is opposite lead end wall 264 so that it is distal to the printhead 250 when installation of the ink tank 260 begins; a first side wall 266 extending from the lead end wall 264 to the trail end wall 265 and intersecting the outlet wall 263, and a second side wall 267 opposite the first side wall 266. The outlet wall 263 includes the outlet port 272 for providing ink to the inlet port 242 of the printhead 250. In some embodiments, as shown in FIG. 6, an electrical device 281 is provided on the outlet wall 263 for tracking ink usage for example. The lead end wall 264 includes a protrusion 261 for engaging with the opening 244 (FIG. 5) in the inner wall 243 of the printhead 250 when the ink tank 260 is installed. A latch lever 282 is provided on the trail end wall 265 to latch the installed ink tank 260 to the printhead 250. The first and second side walls 266 and 267 each include guide features 283 that ride on the partition walls 249 (FIG. 5) as the ink tank 260 is being installed in the printhead 250.

According to embodiments of the present invention, the first and second side walls 266 and 267 each include indentations for attaching a seal retainer as described below. The indentations 290, 292, 295 and 296 are visible on the first side wall 266 in FIG. 6. Similar indentations are on side wall 267 but are not visible in the perspective of FIG. 6. The first indentations 290 are disposed at a first distance s₁ from the outlet wall 263, and the second indentations 292 are disposed at a second distance s₂ from outlet wall 263, where s₂ is greater than s₁. As described below, the first indentations 290 provide lead-ins for attachment of retaining hooks on a seal retainer that presses a seal against outlet port 272 during shipping and storage. The first indentations 290 on the first and second side walls 266 and 267 each include a face 291 that is sloped relative to the outlet wall 263, such that an end of the face 291 that is adjacent the outlet wall 263 is more deeply recessed than the opposite end of face 291. The second indentations 292 on first and second side walls 266 and 267 each include a holding face 293 that is parallel to the corresponding side wall. In some embodiments, the second indentations 292 each include a ramp face 294 that is sloped relative to the corresponding first or second side wall 266 or 267. The ramp face 294 is more deeply indented next to the holding face 293 and slopes outward to meet the first side wall 266 or second side wall 267. The ramp face 294 can have a curved profile. Between the first indentation 290 and the second indentation 292 on each first and second side walls 266 and 267 is a ledge 297 for engaging retaining hooks on the seal retainer. Typically the ledge 297 is parallel to the outlet wall 263. The outlet port 272 includes a first end 273 that is disposed near the lead end wall 264 and a second end 274 disposed distal to the lead end wall 264. The first indentations 290 and the second indentations 292 are disposed near the second end 274 of the outlet port 272. In some embodiments, each side wall (first and second side walls) 266 and 267 also include the third indentations 295 and the fourth indentations 296. In the example of FIG. 6, the third indentations 295 are similar to the first indentations 290 as described above, and the fourth indentations 296 are similar to the second indentations 292 as described above. In other words, the third indentations 295 are located closer to the outlet wall 263 than the fourth indentations 296 are, and the ledge 297 is located between them. The third indentations 295 each include a face that is sloped relative to the outlet wall 263. The fourth indentations 296 each include a holding face that is parallel to the corresponding side wall 266 or 267 and a ramp face that is sloped relative to the corresponding side wall 266 or 267. The third indentations 295 are located near first end 273 of the outlet port 272.

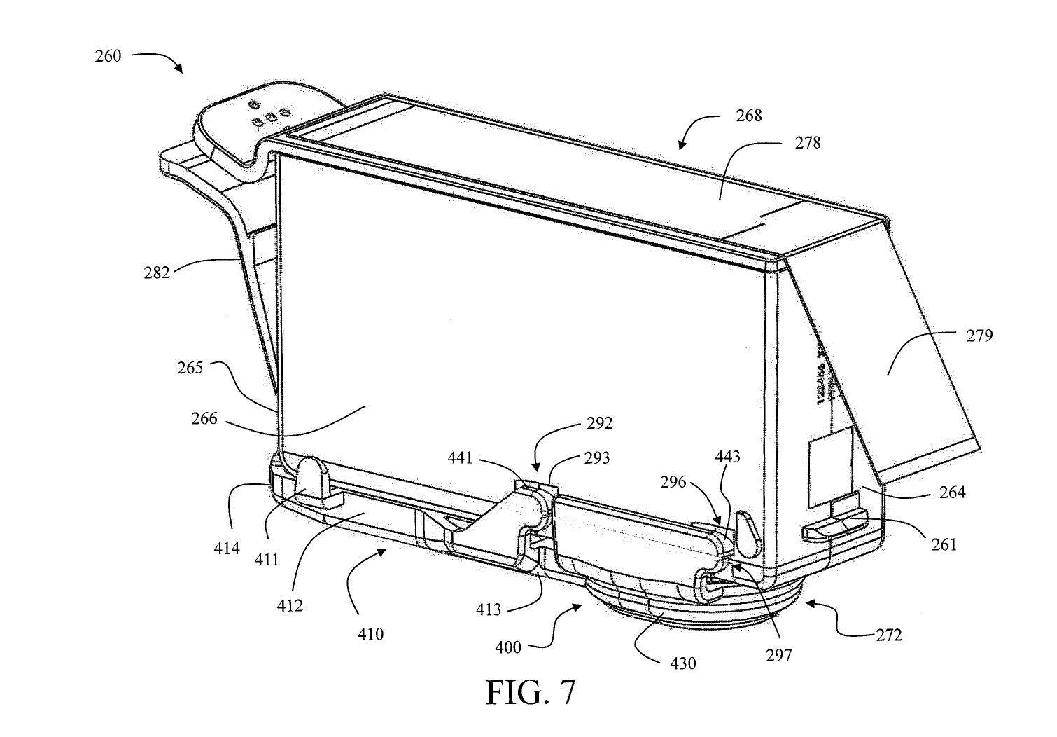

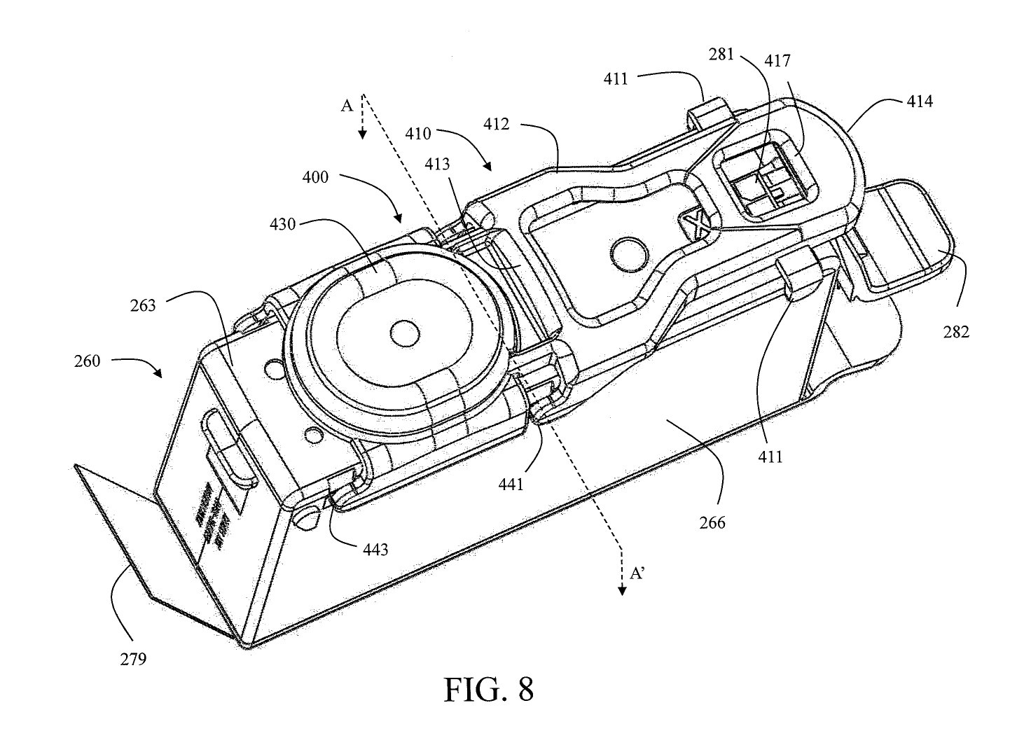

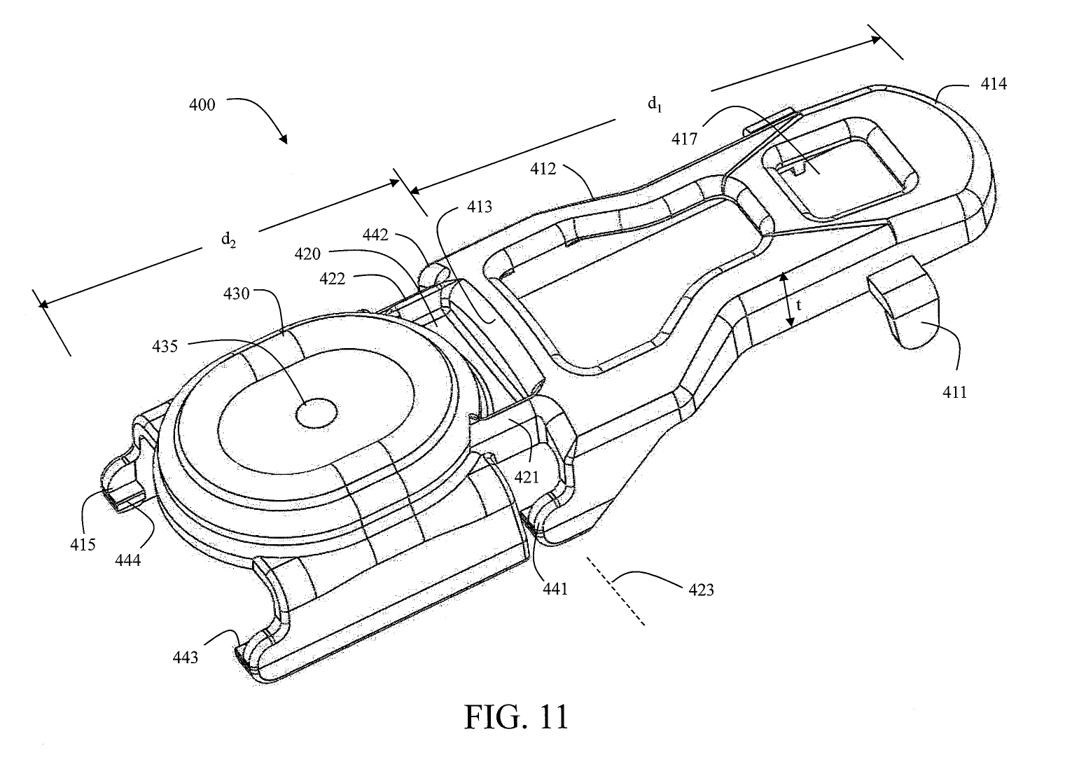

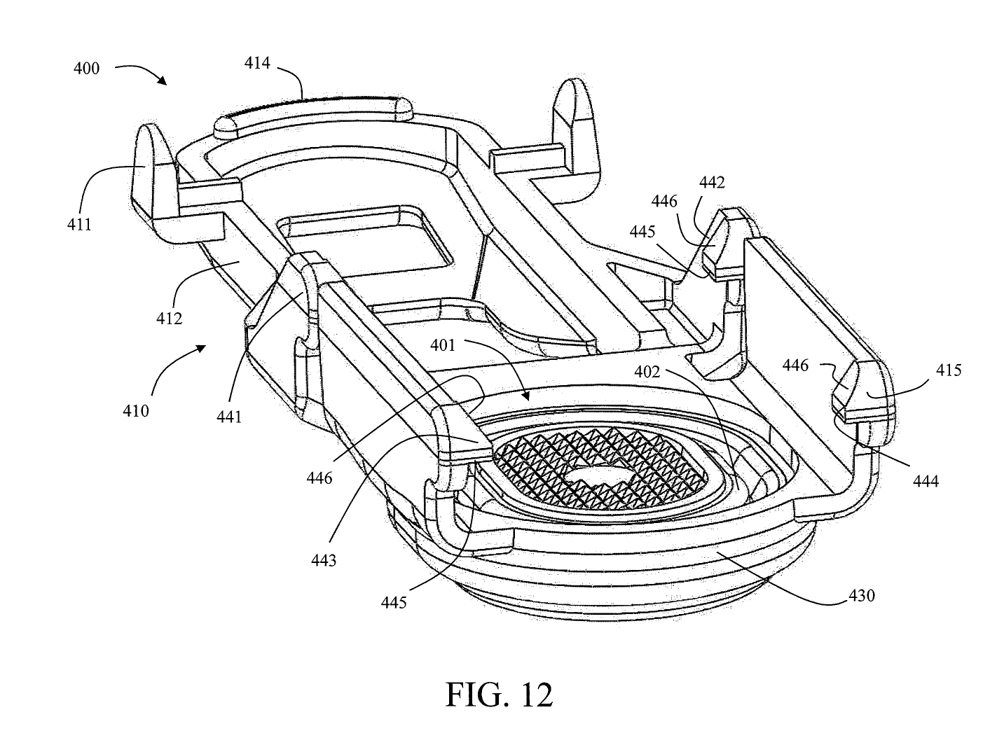

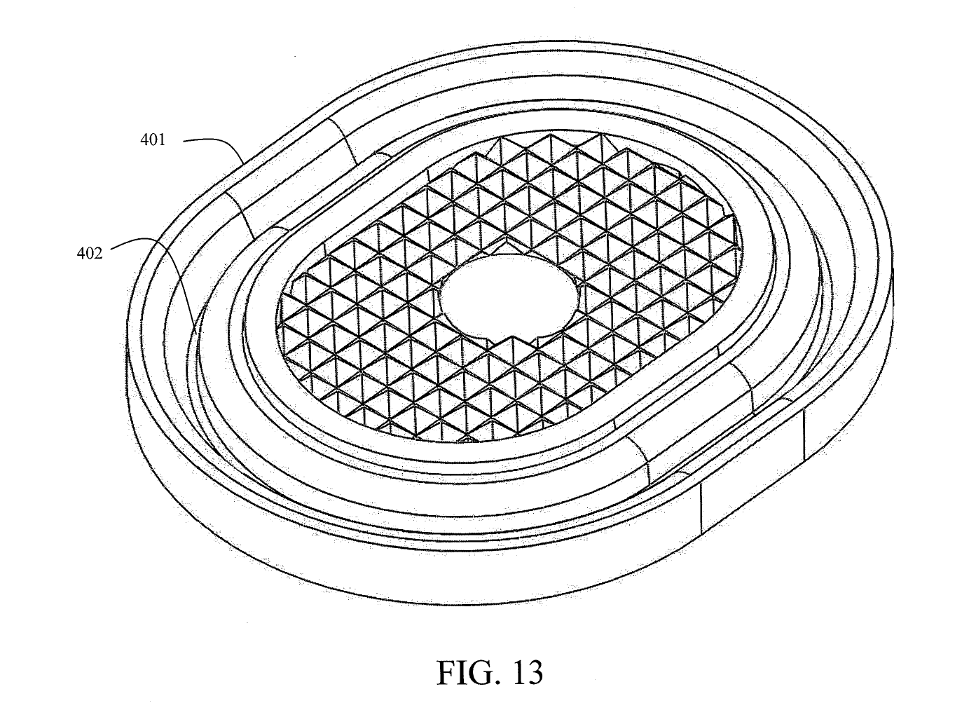

FIG. 7 is a perspective of the ink tank of FIG. 6 with the outlet port 272 facing down and with a removable seal 400 installed over the outlet port 272 according to an embodiment of the present invention. FIG. 8 is similar, but the perspective is rotated to show some of the details more clearly. The seal 400 is sometimes called a shipping seal and is used during shipping and storage of the ink tank 260. The seal 400 needs to provide a reliable seal to inhibit evaporation of volatile components from the ink. It also needs to be easily assembled onto the ink tank 260 and easily removed by the customer before installing the ink tank 260 into the printhead 250. The seal 400 includes a seal retainer 410 that holds a seal member 401 (FIG. 13) in contact with the end face 271 (FIG. 6) of the outlet port 272, as is described in more detail below. The seal retainer 410 includes a housing 430 for the seal member 401 and a handle 412 that is used to help the user remove the seal 400 easily. The seal retainer 410 is held in place on the ink tank 260 by a first hook 441, a second hook 442, a third hook 443 and a fourth hook 444 (the second and fourth hooks of which can be seen more readily in FIGS. 11 and 12). The first hook 441 and third hook 443 are located on a first side of the seal retainer 410, while the second hook 442 and the fourth hook 444 are located on a second side that is opposite the first side. The hooks 441 and 442 are engageable with corresponding ledges 297 between the first indentations 290 and the second indentations 292 on the first side wall 266 and the second side wall 267 respectively. The first hook 441 is disposed in the second indentation 292 on the first side wall 266, and the second hook 442 is disposed in the second indentation 292 on the second side wall 267 (not shown in FIG. 7). The handle 412 includes a free end 414 and a hinged end 413 that is opposite the free end 414. The free end 414 extends beyond the trail end wall 265 of the ink tank 260 so that it is easy for the user to grasp it.

Also shown in FIGS. 7 and 8 is a peel-off label 278 that is adhered to the lid 268. The label 278 covers an air vent (not shown) in the lid 268 to help prevent evaporative loss of ink volatiles. A shrink wrap sleeve (not shown) typically encloses the ink tank 260 during shipping. The shrink wrap sleeve also encloses the seal 400. Alignment guides 411 on both sides of the seal 400 keep the seal retainer 410 and handle 412 aligned along the outlet wall 263 when the shrink wrap is put on the ink tank 260 and seal 400. Alignment guides 411 are located near the free end 414 of the handle 412. A tab 279 extends from the label 278 and is located outside the shrink wrap sleeve. When the user pulls on the tab 279, not only does this remove the label 278 from the vent (not shown) in the lid 268, it also tears the shrink wrap sleeve for removal from the ink tank 260. Then the user can remove the seal 400 as described below.

As seen in FIG. 8, the handle 410 has an opening 417 through which an electrical device 281 on the outlet wall 263 can be accessed. The handle 410 provides mechanical protection for the electrical device 281, for example if the ink tank 260 is dropped while the seal 400 is still in place. However, the electrical device 281 can still be probed while the seal 400 is in place.

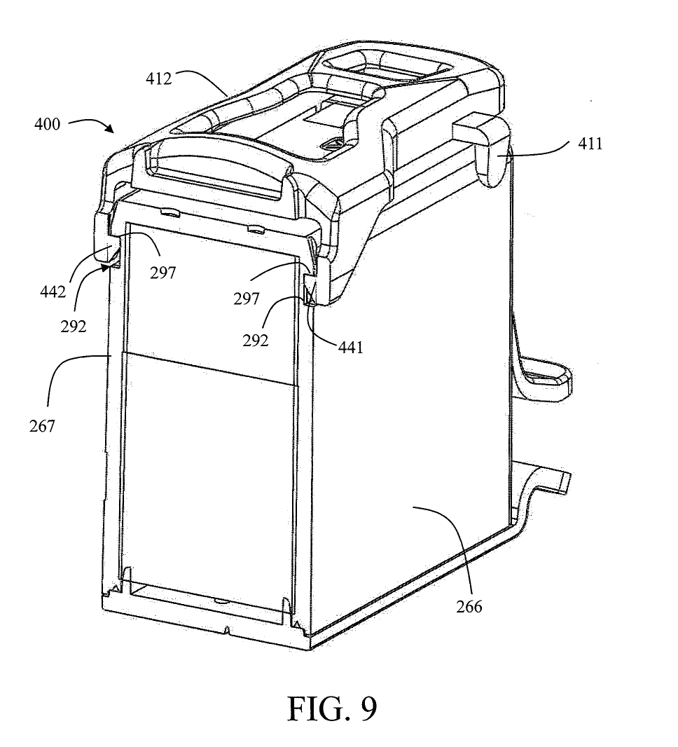

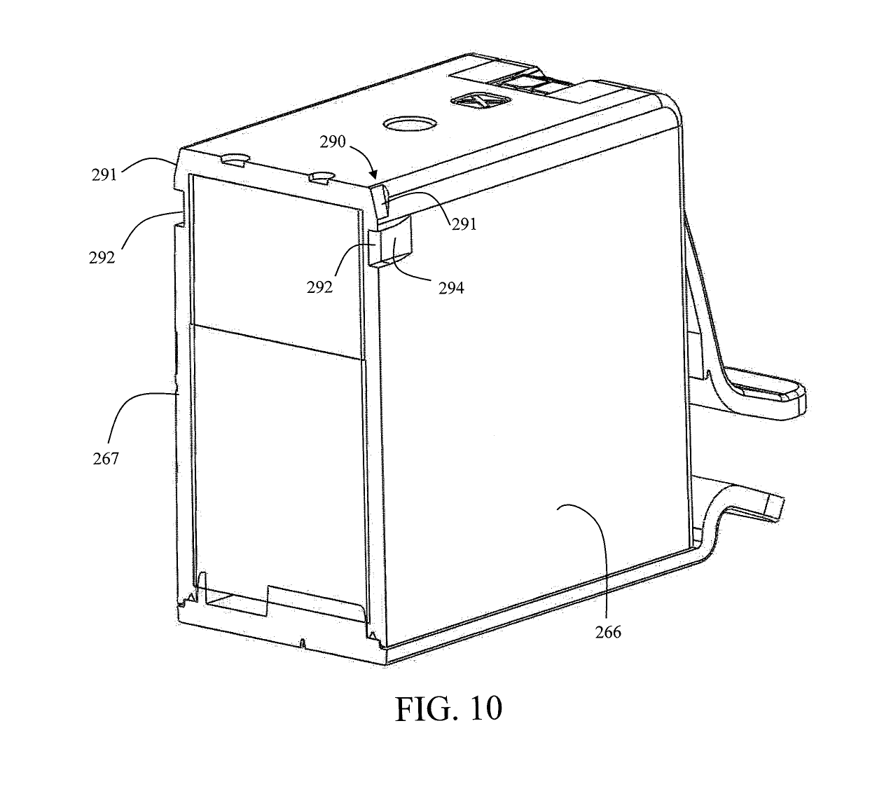

FIG. 9 shows a cross section through A-A′ of FIG. 8 in order to show the first hook 441 disposed in the second indentation 292 and engaged with the ledge 297 on the first side wall 266, and the second hook 442 disposed in the second indentation 292 and engaged with the ledge 297 on the second side wall 267. FIG. 10 is similar to FIG. 9, but with the seal 400 removed. First the indentations 290 including the sloped faces 291 are more clearly shown in FIG. 10. The sloped and curved ramp face 294 in the second indentation 292 on the first sidewall 266 can also be seen. As can be understood by comparing FIG. 9 and FIG. 10, the sloped faces 291 function as lead-ins to spread the first hook 441 and the second hook 442 further apart when the seal 400 is being installed on the ink tank 260. As described in more detail below, the ramp faces 294 spread the first hook 441 and the second hook 442 further apart when the seal 400 is being removed from the ink tank 260.

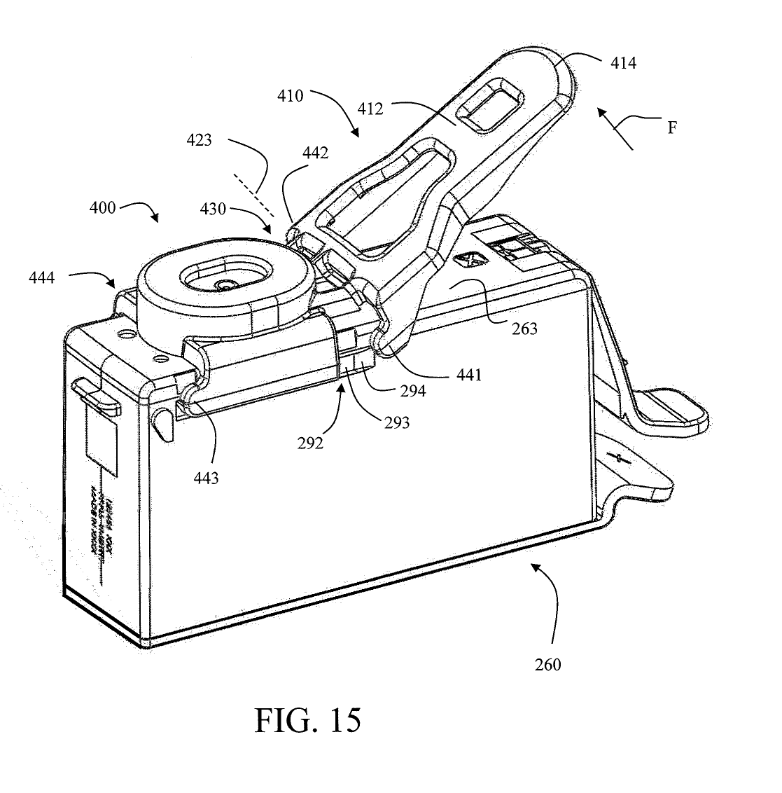

FIG. 11 shows an outer perspective of the seal 400 that is similar to FIG. 8 but without the ink tank 260. A hinge member 420 is located between the housing 430 and the hinged end 413 that is opposite the free end 414 of the handle 412. As seen in FIG. 12, the seal retainer 410 has a first thickness of the housing 430, a second thickness of the handle 412 and a third thickness of the hinge member 420, where the thickness of hinge member 420 is less than the thickness of the housing 430 and the thickness of the handle 412. (Only the thickness t of the handle 412 is designated in FIG. 11 to indicate the direction of the thickness dimension.) As described below relative to FIG. 15, the smaller thickness of the hinge member 420 results in the seal retainer 410 bending at the hinge member 420 around a bend axis 423 when an upward force is applied at the free end 414 of the handle 412 and the housing 430 is locked in place. As shown in FIG. 11, the distance d₁ between the free end 414 and the hinged end 413 of handle 412 is greater than the distance d₂ between the hinged end 413 of the handle 412 and an end 415 of the seal retainer 410 that is opposite the free end 414 of the handle 412. The larger distance d₁ provides greater leverage for bending at the hinge member 420 when an upward force is applied to the free end 414 of the handle 412 as shown in FIG. 15. The first hook 441 and the second hook 442 are located near the hinge member 420, while the third hook 443 and the fourth hook 444 are located near an end 415 of the seal retainer 410 that is opposite the free end 414 of the handle 412. Optionally the seal retainer 410 includes a first rib 421 disposed near the hinge member 420 on the first side of the seal retainer 410 (the same side as first hook 441), and a second rib 422 on the second side of the seal retainer 410 (the same side as second hook 442). The first rib 421 and the second rib 422 have thicknesses that are greater than the thickness of the hinge member 420 and provide additional stiffness at the hinge member 420 that can be beneficial in providing additional sealing strength of the seal member 401 (FIG. 12) at the outlet port 272.

FIG. 12 is an upside down view (relative to FIG. 11) of the seal 400 and shows the seal member 401 within the housing 430 of the seal retainer 410. The seal member 401 is typically formed of an elastomeric material and includes a grooved sealing face 402 that is pressed against the end face 271 of the outlet port 272 (FIG. 6) when the seal 400 is installed on the ink tank 260. The hooks 441, 442, 443 and 444 each include a latch face 445 that is parallel to or substantially parallel to the sealing face 402 of the seal member 401. The latch face 445 engages with the ledge 297 (FIG. 6) when the seal 400 is installed on the ink tank 260. The hooks 441, 442, 443 and 444 also include an engagement face 446 that is obliquely oriented relative to the corresponding the latch face 445. The engagement face 446 rides along the sloped first indentations 290 or the third indentations 295 when the seal 400 is being installed on the ink tank 260 in order to spread out the hooks 441, 442, 443, 444 on opposite sides in order to pass the ledges 297. After passing the ledges 297, the hooks 441 and 442 snap back into place so that they are located in second indentations 292 on the first wall 266 and second wall respectively. Likewise, after passing the ledge 297, hooks 443 and 444 snap back into place so that they are located in fourth indentations 296 of the first wall and second wall 267 respectively. The engagement faces 446 on opposite sides of the seal retainer 410 are obliquely oriented in opposite senses relative to the engagement face 445. As shown in FIG. 12, the engagement face 446 on the fourth hook 444 slopes in the opposite sense as the engagement face 446 on the third hook 443. Although not seen as clearly in the perspective of FIG. 12, the same thing is true of the engagement faces 446 of the first hook 441 and the second hook 442.

FIG. 13 shows the seal member 401 without the seal retainer 410.

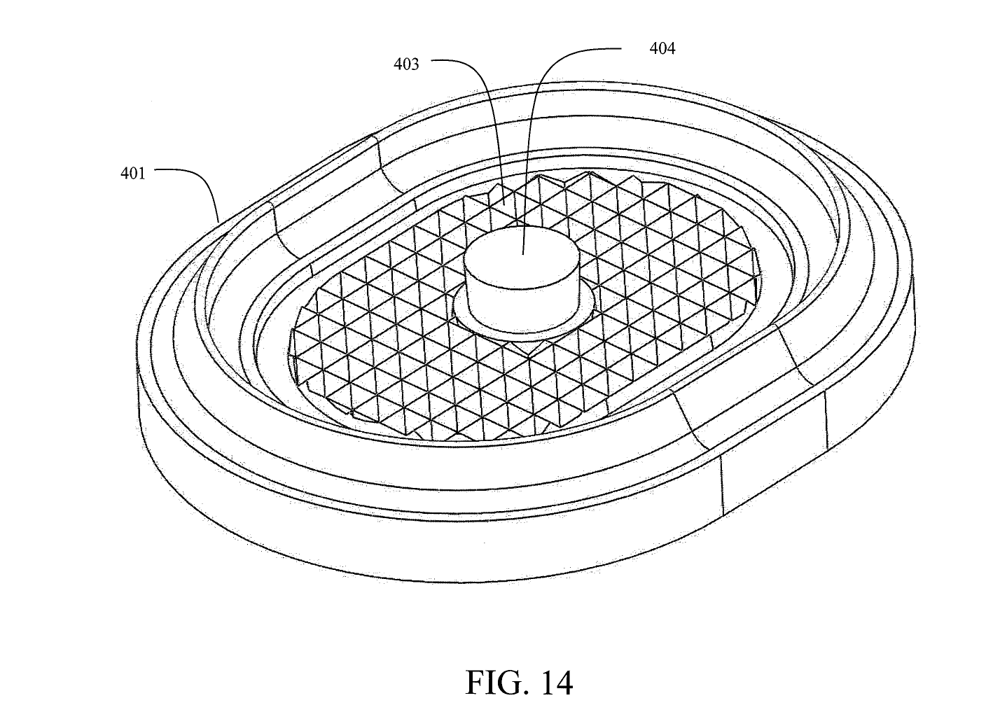

The sealing face 402 is pointing upward in this perspective. FIG. 14 is similar but with the sealing face 402 pointing down so that an attachment face 403 can be seen. The attachment face 403 includes a projection 404 for attachment to housing 430 at a seal attachment 435 (FIG. 11).

The seal 400 is installed on the ink tank 260 in FIGS. 7 and 8. FIG. 15 shows a first step in removing seal 400 from ink tank 260. As the user applies an upward force F to the free end 414 of the handle 412 of the seal retainer 410, the handle 412 moves away from the outlet wall 263 of the ink tank 260. The hinge member 420 bends about the bend axis 423. The first hook 441 and second hook 442 are pulled out of the holding faces 293 of second indentations 292. As the first hook 441 and the second hook 442 are pulled across their corresponding ramp faces 294 they spread out so that they can be removed past the ledges 297 (FIG. 6). At this point, the third hook 443 and the fourth hook 444 are still engaged with their ledges 297.

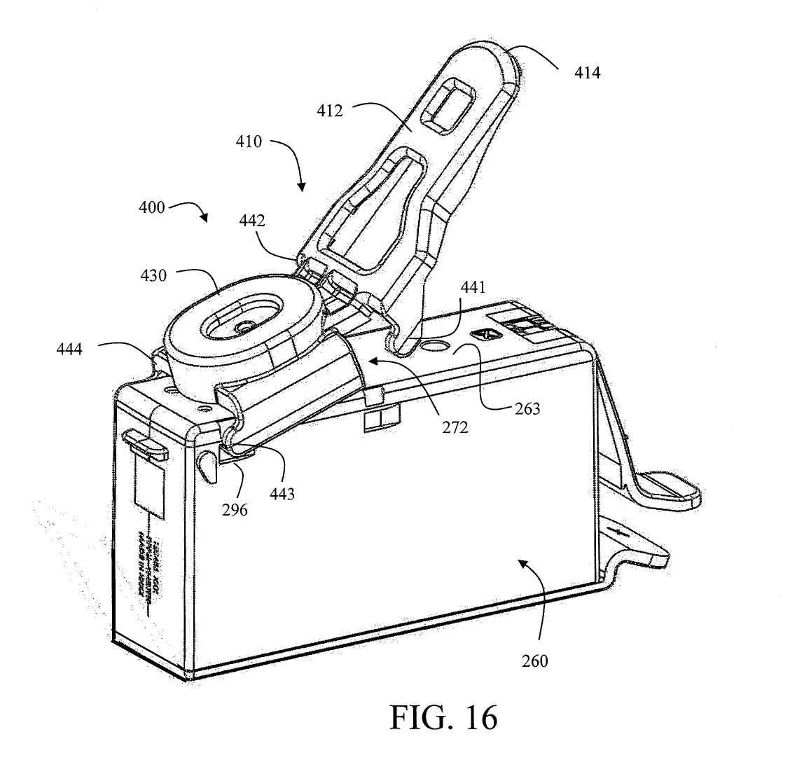

FIG. 16 shows a second step in the removal of seal 400 from the ink tank 260. As the free end 414 of handle 412 continues to be lifted away from the outlet wall 263, the first hook 441 and the second hook 442 are pivoted away from the ink tank 260. The third hook 443 and the fourth hook 444 disengage from fourth indentations 296 in a similar way as described above for the first hook 441 and the second hook 442. The housing 430 pivots away from the outlet port 272. Finally, the seal 400 is lifted away from the ink tank 260, so that the ink tank 260 is ready to install into the printhead 250 (FIG. 5).

The invention has been described in detail with particular reference to certain preferred embodiments thereof, but it will be understood that variations and modifications can be effected within the spirit and scope of the invention.

### PARTS LIST

10 Inkjet printer system
12 Image data source
14 Controller
15 Image processing unit
16 Electrical pulse source
18 First fluid source
19 Second fluid source
20 Recording medium
100 Inkjet printhead
110 Inkjet printhead die
111 Substrate
120 First nozzle array
121 Nozzle(s)
122 Ink delivery pathway (for first nozzle array)
130 Second nozzle array
131 Nozzle(s)
132 Ink delivery pathway (for second nozzle array)
181 Droplet(s) (ejected from first nozzle array)
182 Droplet(s) (ejected from second nozzle array)
200 Carriage
240 Standpipe
241 Holding receptacle
242 Inlet port
243 Inner wall
244 Opening
245 End
247 Gasket
249 Partitioning wall
250 Printhead
251 Printhead die

### Parts List Cont'd

253 Nozzle array
254 Nozzle array direction
256 Encapsulant
257 Flex circuit
258 Connector board
260 Ink tank
261 Protrusion
263 Outlet wall
264 Lead end wall
265 Trail end wall
266 First side wall
267 Second side wall
268 Lid
270 Body
271 End face (of outlet port)
272 Outlet port
273 First end (of outlet port)
274 Second end (of outlet port)
277 Wick
278 Label
279 Tab
281 Electrical device
282 Latch lever
283 Guide feature
290 First indentation
291 Face (of first indentation)
292 Second indentation
293 Holding face (of second indentation)
294 Ramp face (of second indentation)
295 Third indentation

### Parts List Cont'd

296 Fourth indentation
297 Ledge
300 Printer chassis
302 Paper load entry direction
303 Print region
304 Media advance direction
305 Carriage scan direction
306 Right side of printer chassis
307 Left side of printer chassis
308 Front of printer chassis
309 Rear of printer chassis
310 Hole (for paper advance motor drive gear)
311 Feed roller gear
312 Feed roller
313 Forward rotation direction (of feed roller)
320 Pick-up roller
322 Turn roller
323 Idler roller
324 Discharge roller
325 Star wheel(s)
330 Maintenance station
370 Stack of media
371 Top piece of medium
380 Carriage motor
382 Carriage guide rail
383 Encoder fence
384 Belt
390 Printer electronics board
392 Cable connectors

### Parts List Cont'd

400 Seal
401 Seal member
402 Sealing face
403 Attachment face
404 Projection
410 Seal retainer
411 Alignment guide
412 Handle
413 Hinged end
414 Free end
415 End (of seal retainer)
417 Opening (in handle)
420 Hinge member
421 First rib
422 Second rib
423 Bend axis
430 Housing
435 Seal attachment
441 First hook
442 Second hook
443 Third hook
444 Fourth hook
445 Latch face
446 Engagement face

1. A seal for an outlet port of an ink tank, the seal comprising:
a seal member; and
a seal retainer comprising;
a housing for the seal member;
a first hook on a first side of the seal retainer;
a second hook on a second side of the seal retainer, the second side being opposite the first side;
a handle including a free end and a hinged end opposite the free end; and
a hinge member disposed between the housing and the free end of the handle, wherein a distance between the free end of the handle and the hinged end of the handle is greater than a distance between the hinged end of the handle and an end of the seal retainer that is opposite the free end of the handle; wherein the seal retainer has a first thickness of the housing, a second thickness of the handle, and a third thickness of the hinge member, wherein the third thickness is less than the first thickness and the second thickness.

2. The seal of claim 1, wherein the first hook and the second hook are disposed proximate the hinge member.

3. The seal of claim 1, wherein the seal retainer further comprises:
a third hook on the first side of the seal retainer; and
a fourth hook on the second side of the seal retainer.

4. The seal of claim 3, wherein the third hook and the fourth hook are disposed proximate the end of the seal retainer that is opposite the free end of the handle.

5. (canceled)

6. The seal of claim 1 wherein the seal retainer further includes a first rib disposed proximate the hinge member on the first side of the seal retainer, and a second rib disposed proximate the hinge member on the second side of the seal retainer, wherein the first rib and the second rib have thicknesses that are greater than the third thickness of the hinge member.

7. The seal of claim 1, wherein the seal retainer further comprises:
a first alignment guide disposed on the first side of the seal retainer, and
a second alignment guide disposed on the second side of the seal retainer.

8. The seal of claim 7, wherein the first alignment guide and the second alignment guide are disposed proximate the free end of the handle.

9. The seal of claim 1, wherein the handle includes an opening for accessing an electronic device that is mounted on the ink tank.

10. The seal of claim 1, wherein the seal member is formed of an elastomeric material.

11. The seal of claim 1, wherein the seal member comprises a sealing face and an attachment face opposite the sealing face, the attachment face including at least one projection for attachment to the housing.

12. The seal of claim 11, wherein the first hook includes a latch face that is parallel to or substantially parallel to the sealing face of the seal member.

13. The seal of claim 12, wherein the first hook includes an engagement face that is obliquely oriented relative to the latch face.

14. The seal of claim 13, wherein the second hook includes:
a latch face that is parallel to or substantially parallel to the sealing face of the seal member; and
an engagement face that is obliquely oriented to the latch face in an opposite sense relative to the engagement face of the first hook.
